(19) United States
(12) Patent Application Publication
(10) Pub. No.: US 2025/0077960 A1
(43) Pub. Date: Mar. 6, 2025

(54) FEATURE SELECTION FOR REINFORCEMENT LEARNING MODELS

(71) Applicant: Capital One Services, LLC, McLean, VA (US)

(72) Inventor: Ziyi YE, Plano, TX (US)

(21) Appl. No.: 18/462,013

(22) Filed: Sep. 6, 2023

(51) Int. Cl. G06N 20/00

(52) U.S. Cl. CPC G06N 20/00

(57) ABSTRACT

In some implementations, a device may determine a set of features for the machine learning model. The device may determine, using off-policy evaluation, a performance level of the machine learning model associated with the set of features. The device may determine, based on the performance level, a ranking of the set of features. The device may generate, based on the ranking, one or more subsets of features from the set of features. The device may determine, using the off-policy evaluation, performance levels of the machine learning model for respective subsets of features from the one or more subsets of features. The device may select, based on the performance levels, a subset of features from the one or more subsets of features. The device may obtain, via the machine learning model, one or more recommendations that are based on input data, wherein the machine learning model uses the subset of features.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for feature selection for a reinforcement learning model. The system may include one or more memories and one or more processors communicatively coupled to the one or more memories. The one or more processors may be configured to determine, via one or more logistic regression feature selection models, a set of features for the reinforcement learning model. The one or more processors may be configured to determine, using off-policy evaluation, a performance level of the reinforcement learning model when using the set of features. The one or more processors may be configured to determine, based on the performance level and using a classification model, a ranking of the set of features, wherein the ranking indicates an order of importance of the set of features on the performance level. The one or more processors may be configured to generate one or more subsets of features from the set of features based on iteratively removing one or more features, from the set of features, in accordance with the ranking. The one or more processors may be configured to determine, using the off-policy evaluation, one or more performance levels for respective subsets of features from the one or more subsets of features. The one or more processors may be configured to select a subset of features, from the one or more subsets of features, to be used for the reinforcement learning model based on the one or more performance levels.

Some implementations described herein relate to a method of feature selection for a machine learning model. The method may include determining, by a device, a set of features for the machine learning model. The method may include determining, by the device and using off-policy evaluation, a performance level of the machine learning model associated with the set of features. The method may include determining, by the device and based on the performance level, a ranking of the set of features. The method may include generating, by the device and based on the ranking, one or more subsets of features from the set of features. The method may include determining, by the device and using the off-policy evaluation, performance levels of the machine learning model for respective subsets of features from the one or more subsets of features. The method may include selecting, by the device and based on the performance levels, a subset of features from the one or more subsets of features. The method may include obtaining, by the device and via the machine learning model, one or more recommendations that are based on input data, wherein the machine learning model uses the subset of features.

Some implementations described herein relate to a non-transitory computer-readable medium that stores a set of instructions. The set of instructions, when executed by one or more processors of a device, may cause the device to determine, via one or more logistic regression feature selection models, a set of features for a reinforcement learning model. The set of instructions, when executed by one or more processors of the device, may cause the device to determine, using off-policy evaluation, a performance level of the reinforcement learning model when using the set of features. The set of instructions, when executed by one or more processors of the device, may cause the device to determine, based on the performance level and using a classification model, a ranking of the set of features, wherein the ranking indicates an order of importance of the set of features on the performance level. The set of instructions, when executed by one or more processors of the device, may cause the device to generate one or more subsets of features from the set of features based on iteratively removing one or more features, from the set of features, in accordance with the ranking. The set of instructions, when executed by one or more processors of the device, may cause the device to determine, using the off-policy evaluation, one or more performance levels for respective subsets of features from the one or more subsets of features. The set of instructions, when executed by one or more processors of the device, may cause the device to select, based on the one or more performance levels, a subset of features from the one or more subsets of features. The set of instructions, when executed by one or more processors of the device, may cause the device to provide the subset of features for use with the reinforcement learning model.

### BRIEF DESCRIPTION OF THE DRAWINGS

FIGS. 1A-1C are diagrams of an example associated with feature selection for reinforcement learning models, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with feature selection for reinforcement learning models, in accordance with some embodiments of the present disclosure.

FIG. 4 is a flowchart of an example process associated with feature selection for reinforcement learning models, in accordance with some embodiments of the present disclosure.

### DETAILED DESCRIPTION

The following detailed description of example implementations refers to the accompanying drawings. The same reference numbers in different drawings may identify the same or similar elements.

Reinforcement learning is a subfield of machine learning that is associated with developing algorithms capable of making optimal decisions in dynamic environments. Reinforcement learning may be associated with training a model to interact with an environment, learn from experiences, and optimize behavior over time. The model may receive feedback in the form of rewards or penalties based on actions, and the objective may be to maximize the cumulative reward the model obtains. A reinforcement learning model may “learn” through trial and error, iteratively exploring the environment, taking actions, and observing the consequences.

In some examples, a reinforcement learning model may use one or more logistic regression models. A logistic regression model may apply a logistic function, also known as a sigmoid function, to a linear combination of the input features and associated weights. The sigmoid function may map the linear combination to a probability value between 0 and 1, representing the likelihood of a binary outcome. In a logistic regression model, the weights may be learned through a process of maximum likelihood estimation. The logistic regression model may aim to find the optimal set of weights that maximizes the likelihood of the observed data. This is typically achieved using iterative optimization algorithms, such as gradient descent. During training, the logistic regression model may adjust the weights based on the prediction errors, seeking to minimize the difference between the predicted probabilities and the actual binary labels.

Feature selection is a process in machine learning that involves identifying and selecting the most relevant and informative features from a given dataset to be used as input(s) to a machine learning model. The goal of feature selection may be to reduce dimensionality, improve model performance, and/or enhance interpretability, among other examples. For example, a data set used as an input for a machine learning model may be associated with high dimensionality. High dimensionality in datasets presents several challenges for machine learning models. First, the “curse of dimensionality” may refer to the phenomenon where the number of features exceeds the available data points, leading to sparse data. This can result in overfitting, as the machine learning model may be unable to generalize from limited samples. Additionally, high dimensionality increases the computational complexity and memory requirements for training and inferences performed via a machine learning model, thereby consuming significant computing resources, processing resources, and/or memory resources, among other examples. Feature redundancy and collinearity can also arise from high dimensional datasets, an interpretability of a machine learning model and/or resulting in unstable or unreliable results. To address these problems, feature selection and dimensionality reduction techniques may be employed to extract meaningful information and reduce the number of features while preserving essential patterns in the data.

In some cases, a feature selection model (or technique) may be designed based on the type of machine learning model for which the feature selection model is selecting features. For example, a logistic regression feature selection model may aim to identify the most relevant predictors for binary outcome prediction. Different techniques may be utilized, such as filter methods (e.g., correlation), wrapper methods (e.g., recursive feature elimination (RFE)), embedded methods (e.g., L1 regularization), and/or dimensionality reduction techniques (e.g., principal component analysis (PCA)). Each method may be designed to improve an accuracy of a particular type of machine learning model, such as a logistic regression model or a classification model.

However, in some cases, a machine learning model may use a combination of different types of machine learning models. In such cases, a given feature selection model (e.g., that is designed for a particular type of machine learning model included in the different types of machine learning models) may be used to select features for the machine learning model that uses a combination of different types of machine learning models. However, because the given feature selection model is designed for the particular type of machine learning model (e.g., and not the combination of different types of machine learning models), the given feature selection model may select features for the machine learning model that result using one or more features that do not improve a performance of the machine learning model. As a result, a dimensionality of a data set for the machine learning model may be increased without an improvement in performance, thereby consuming computing resources, processing resources, and/or memory resources, among other examples, associated with the higher dimensionality.

As described above, in some cases, RFE may be used as a feature selection technique. RFE may be associated with training a machine learning model on the entire set of input features and assigning each feature a weight or ranking based on its importance in the model's performance (e.g., where the weight or ranking may be based on a metric, such as feature coefficients, feature importance scores, and/or the reduction in model performance after removing a feature). When using RFE, a predefined number or percentage of features with the lowest rankings may be removed from the set of input features. The remaining features are then used to retrain the machine learning model, and the process is repeated until a specified number of features are left or a certain stopping criterion is met. However, RFE may be associated with significant processing and/or computing overhead associated with repeatedly training and evaluating the machine learning model with different subsets of features. For example, RFE feature selection may include re-training the model each time a feature is removed, thereby consuming computing resources, processing resources, and/or memory resources, among other examples. Additionally, RFE may produce inconsistent results when applied to different subsets or samples of a dataset. Small changes in the dataset or the random initialization of the algorithm can result in different feature rankings and selection outcomes when using RFE. This variability introduces challenges associated with establishing a definitive set of selected features. Further, while RFE may aim to improve model interpretability by reducing the number of features, RFE may not improve a generalization performance of the machine learning model. For example, the selected features may not represent the most relevant features for different datasets or unseen data (e.g., the performance of the machine learning model on the training data may not necessarily reflect the performance on real-world or test data).

Some implementations described herein enable feature selection for reinforcement learning models. For example, some implementations enable a feature selection technique for a reinforcement learning machine learning model that uses a combination of one or more logistic regression models and one or more classification models. In some implementations, a feature selection device may use off-policy evaluation of a machine learning model to facilitate feature selection for the machine learning model. In some implementations, the feature selection device may use one or more logistic regression feature selection models (e.g., one or more feature selection techniques associated with, or designed for, a logistic regression model) to determine an initial set of features for the machine learning model. The feature selection device may evaluate a performance of the machine learning model (e.g., using the initial set of features) using off-policy evaluation. The feature selection device may iteratively remove one or more features from the initial set of features and evaluate the performance of the machine learning model using off-policy evaluation until a subset of features, from the initial set of features, is selected by the feature selection device (e.g., based on evaluated performance levels of the machine learning model using off-policy evaluation).

For example, the feature selection device may determine, via one or more logistic regression feature selection models, a set of features for the reinforcement learning model. The feature selection device may determine, using off-policy evaluation, a performance level of the reinforcement learning model when using the set of features. The feature selection device may determine, based on the performance level and using a classification model, a ranking of the set of features. The ranking may indicate an order of importance of the set of features on the performance level. The feature selection device may generate one or more subsets of features from the set of features based on iteratively removing one or more features, from the set of features, in accordance with the ranking (e.g., by iteratively removing the least important features). The feature selection device may determine, using the off-policy evaluation, one or more performance levels for respective subsets of features from the one or more subsets of features. The feature selection device may select a subset of features, from the one or more subsets of features, to be used for the reinforcement learning model based on the one or more performance levels.

As a result, a dimensionality of the input data for the reinforcement learning model may be reduced. This may conserve consuming computing resources, processing resources, and/or memory resources, among other examples, that would have otherwise been used for input data associated with a higher dimensionality. Additionally, by using off-policy evaluation of the reinforcement learning model during the feature selection process, different sets or subsets of features may be evaluated without re-training the reinforcement learning model (e.g., the reinforcement learning model may be evaluated on a different policy or data distribution than the one the reinforcement learning model was trained on using off-policy evaluation), thereby conserving computing resources, processing resources, and/or memory resources, among other examples, that would have otherwise been used to collect data for each of the different sets or subsets of features, re-train the reinforcement learning model for each of the different sets or subsets of features, and/or execute the reinforcement learning model (e.g., after re-training) for each of the different sets or subsets of features, among other examples. Further, by using the off-policy evaluation of the reinforcement learning model during the feature selection process, a set (or subset) of features that improves the personalization effect or performance of the reinforcement learning model may be selected (e.g., by enabling a benefit for personalization compared to a processing cost of using a given feature to be quickly and easily evaluated via the off-policy evaluation).

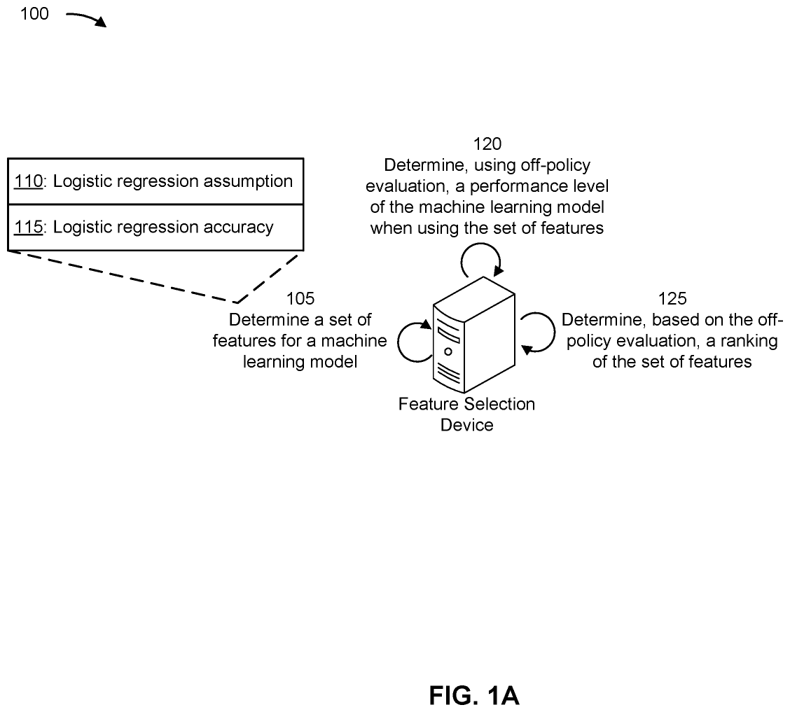

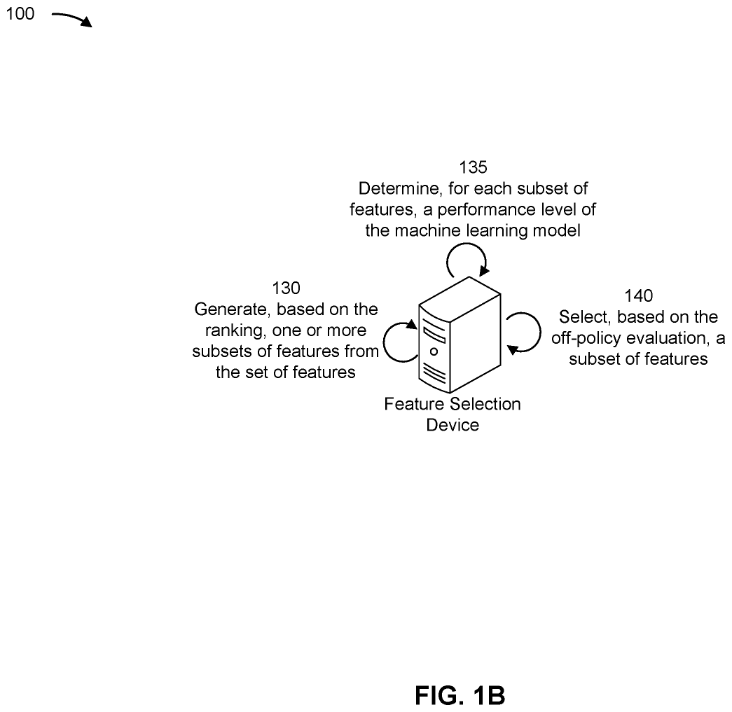

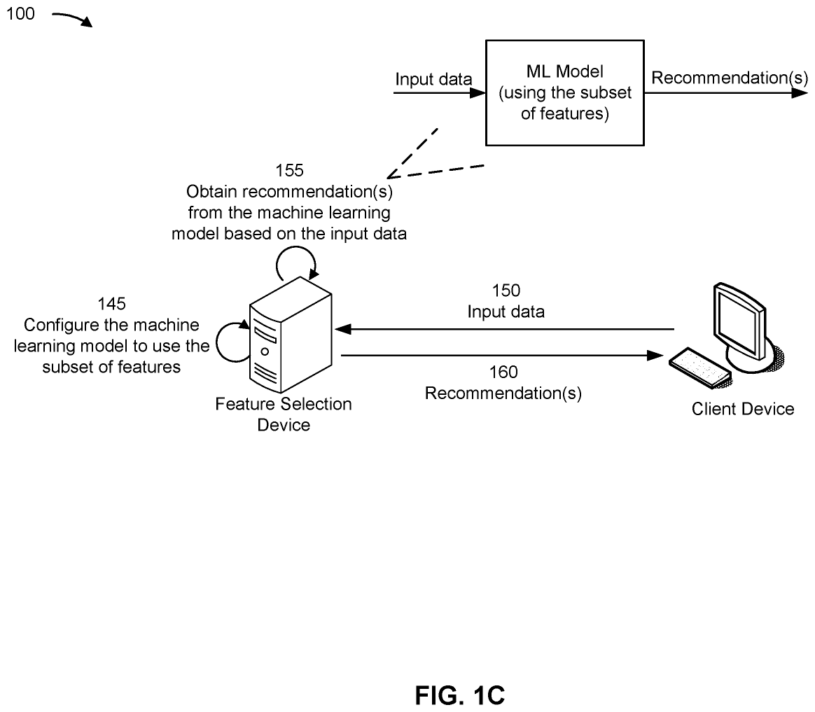

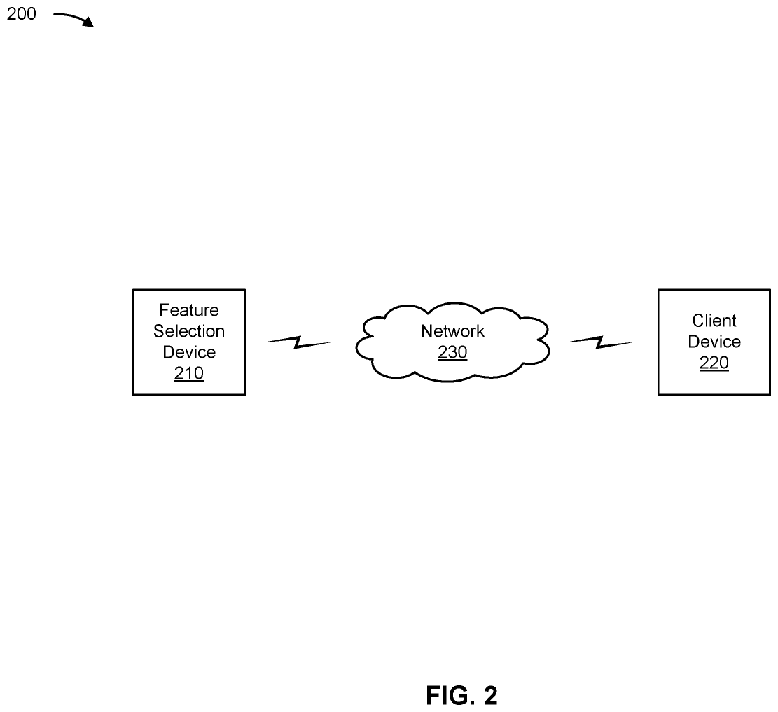

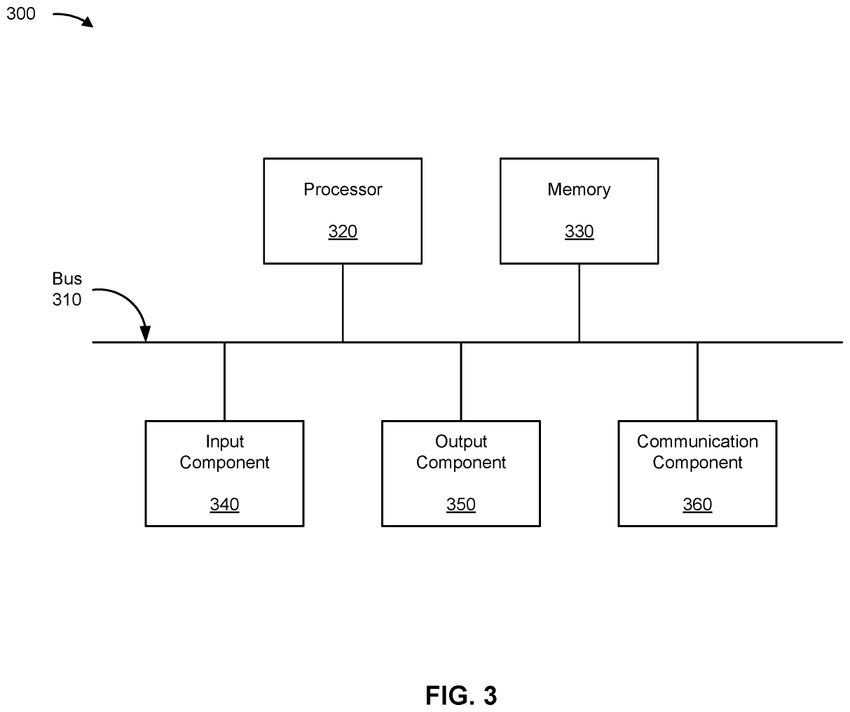

FIGS. 1A-1C are diagrams of an example 100 associated with feature selection for reinforcement learning models. As shown in FIGS. 1A-1C, example 100 includes a feature selection device and a client device. These devices are described in more detail in connection with FIGS. 2 and 3.

The feature selection device may select features for a machine learning model. The machine learning model may be a reinforcement learning model. The machine learning model may be configured to output one or more recommendations based on input data. In some implementations, the machine learning model may include one or more logistic regression models (e.g., one or more Bayesian logistic regression models). In some implementations, the machine learning model may be a multinomial Bayesian logistic regression model. For example, the machine learning model may include Bayesian logistic regression models for respective categories or respective classifications. In some implementations, the machine learning model may be associated with multiple logistic regression models. The machine learning model may be configured to classify or categorize input data based on outputs of respective logistic regression models. For example, the machine learning model may include a classification model that classifies an input based on outputs of the one or more (or the multiple) logistic regression models.

As shown in FIG. 1A, and by reference number 105, the feature selection device may determine a set of (e.g., one or more) features for the machine learning model. For example, the feature selection device may determine, via one or more logistic regression feature selection models or techniques, a set of features for the machine learning model. As described elsewhere herein, a logistic regression feature selection model or technique may be a feature selection model or technique that is associated with, or designed for, a logistic regression model (e.g., a Bayesian logistic regression model). For example, a logistic regression feature selection model or technique may be a feature selection model or technique that is associated with, or designed to, improve a performance of a logistic regression model. For example, the one or more logistic regression feature selection models or techniques may enable the feature selection device to select one or more features (e.g., a set of features) that improve a performance of the machine learning model associated with predicted a generalized recommendation (e.g., a general response prediction). The generalized recommendation may be a recommendation that is generalized for different datasets and/or different users.

For example, as shown by reference number 110, the feature selection device may determine one or more features for the machine learning model using one or more logistic regression assumptions for feature selection. For example, the feature selection device may select one or more features that satisfy one or more logistic regression assumptions. For example, the one or more logistic regression assumptions may include a linearity of the log-odds (logit) of an outcome variable (e.g., an assuming that the logit of the outcome variable is a linear combination of one or more predictor variables), an independence of observations (e.g., an assumption that observations are independent of each other), an absence of multicollinearity (e.g., an assumption that there is no perfect multicollinearity because this can make it challenging to estimate the contribution of individual predictors), no outliers (e.g., an assumption of the absence of influential outliers that can disproportionately affect estimated coefficients), a large sample size (e.g., an assumption of relatively large sample size to provide stable estimates and reliable inference), an independence of errors (e.g., an assumption that errors or residuals are independent of each other, implying that there is no systematic pattern or correlation among the residuals), and/or binary or categorical outcomes (e.g., an assumption of a binary or categorical outcome), among other examples.

For example, the feature selection device may perform a multicollinearity check for a set of features. Multicollinearity may refers to high correlation or linear dependence among predictor variables, which can lead to unstable coefficient estimates and difficulties in interpreting the effects of individual predictors. The feature selection device may perform the multicollinearity check to identify one or more variables (e.g., one or more features) that are highly correlated. The feature selection device may remove the one or more features (e.g., that are highly correlated) from the set of features. For example, the feature selection device may determine a correlation matrix among the set of features. High correlation coefficients (within a threshold of 1 or −1) determined via the correlation matrix may indicate multicollinearity (or high correlation) between two or more features. As another example, the feature selection device may determine a variance inflation factor (VIF) for respective features. VIF may be a measure of an extent to which the variance of estimated regression coefficients is inflated due to multicollinearity. The feature selection device may determine a VIF for each feature from the set of features. The feature selection device may remove any features, from the set of features, associated with a VIF that satisfies a VIF threshold (e.g., the feature selection device may remove any features with high VIFs). The feature selection device may use other techniques (such as a Chi-square test) for performing the multicollinearity check for the set of features in addition to, or in place of, one or more of the examples described above.

Additionally, or alternatively, the feature selection device may determine one or more features, from the set of features, that are associated with low variance. A low variance features may refers to a feature that does not provide sufficient discriminatory power (e.g., that tend to have little or no variation across a dataset, resulting in less information for the machine learning model). For example, the feature selection device may calculate a variance for each feature included in the set of features. Variance may be a measure of a spread or variability of values associated with a feature. The feature selection device may determine whether variances of respective features satisfy a variance threshold. The feature selection device may remove one or more features that are associated with variances that do not satisfy the variance threshold (e.g., may remove features associated with low variance).

Additionally, or alternatively, the feature selection device may perform a linearity check for the set of features. For example, as described above, logistic regression may assume a linear relationship between predictor variables (e.g., features) and the log-odds of an outcome variable (e.g., and not necessarily a linear relationship between the features and the outcome itself). The feature selection device may remove one or more features, from the set of features, to ensure linearity for the machine learning model. For example, the feature selection device may determine (or access) linearity via one or more techniques, such as a scatterplot, a partial regression plot, a Box-Tidwell transformation, polynomial terms, and/or one or more non-parametric techniques, among other examples.

Additionally, or alternatively, as shown by reference number 115, the feature selection device may determine one or more features for the machine learning model using an evaluation of logistic regression accuracy for feature selection. For example, the feature selection device may use a set of features determines from the one or more logistic regression assumptions for feature selection (e.g., as described in connection with reference number 110) to evaluate a logistic regression accuracy of the machine learning model for feature selection. For example, the feature selection device may evaluate the set of features impact on a performance of the logistic regression model(s) included in the machine learning model. As an example, the feature selection device may determine p-values for each feature included in the set of features. A p-value may be a measure of a strength of evidence against a null hypothesis (e.g., indicating a probability of observing the estimated relationship between features and the outcome by chance, assuming the null hypothesis is true (i.e., no association between features and the outcome)). For example, a low p-value may indicate evidence against the null hypothesis and implying an association between the predictor variable and the outcome. A large p-value may indicate weak evidence against the null hypothesis and suggests a lack of statistical significance. The feature selection device may determine whether p-values of respective features satisfy a significance threshold. If a p-value for a given feature satisfies the significance threshold, then the feature selection device may remove the given feature from the set of features (e.g., the feature selection device may remove features associated with high p-values).

As another example, the feature selection device may determine confidence intervals for respective features. For example, a confidence interval may be associated with a range of plausible values for an odds ratio or coefficient of a given feature. A wider (or larger) confidence interval may indicate greater uncertainty about the feature, while a narrower interval may indicate higher precision. The feature selection device may remove one or more features associated with confidence intervals that do not satisfy a confidence threshold (e.g., the feature selection device may remove feature(s) associated with wide or large confidence intervals). Additionally, or alternatively, the feature selection device may perform RFE using the set of features determines from the one or more logistic regression assumptions for feature selection (e.g., as described in connection with reference number 110). In some implementations, the feature selection device may perform RFE with cross validation (RFECV). For example, the feature selection device may perform RFECV to maximize an area under the receiver operating characteristic curve for the machine learning model. This enables the feature selection device to determine a set of features that are most relevant and/or informative for the one or more logistic regression models included in the machine learning model. As a result, this may improve a performance of the one or more logistic regression models.

In some implementations, the feature selection device may determine the set of features using multiple logistic regression accuracy models associated with respective logistic regression models from the multiple logistic regression models included in the machine learning model. In other words, the feature selection device may separately evaluate the accuracy of each logistic regression model included in the machine learning model as part of selecting the set of features for the machine learning model, in a similar manner as described above.

As described above, the feature selection technique may determine a set of features based on the one or more logistic regression feature selection models or techniques (e.g., as described in connection with reference number 110 and/or reference number 115). As shown by reference number 120, the feature selection device may determine, using off-policy evaluation, a performance level of the machine learning model when using the set of features. For example, the machine learning model may be associated with classification to distinguish one user from another user (e.g., to provide a more personalized recommendation). The logistic regression feature selection models and/or techniques may improve performance or a accuracy of a given logistic regression model, but may not improve or impact the personalization performance of the machine learning model as a whole. The off-policy evaluation aspects described herein may enable the feature selection device to select feature(s) that improve the personalization performance of the machine learning model. For example, using the off-policy evaluation aspects may enable the feature selection device to determine one or more features that enable the machine learning model to differentiate different people and/or users to provide more personalized recommendations.

In some implementations, the feature selection device may use a random holdout dataset for the off-policy evaluation. In other words, the off-policy evaluation may include a random holdout direct matching evaluation. For example, the feature selection device may divide available data into a training set and a holdout (e.g., validation or test) set. The feature selection device may randomly divide the available data into one of the two sets. The feature selection device may train the machine learning model using the training set. The feature selection device may evaluate the performance of the machine learning model (e.g., using the holdout set) by evaluating a behavior or performance of the model on a different policy or data distribution than was used for training. For example, the feature selection device may estimate an expected reward or performance of the machine learning model when deployed on a target policy (e.g., without actually deploying the machine learning model and collecting new data, thereby conserving processing resources, computing resources, and/or memory resources). This enables the feature selection device to determine a performance level of the machine learning model on a target policy using historical data that was collected under a different policy.

For example, the machine learning model may be trained using a first set of features. The feature selection device may evaluate a performance of a second set of features for the machine learning model using off-policy evaluation (e.g., where the target policy includes using the second set of features). The second set of features may be the set of features that are determined based on the one or more logistic regression feature selection models or techniques (e.g., as described in connection with reference number 110 and/or reference number 115). This enables the feature selection device to estimate a performance of the machine learning model for the set of features that are determined based on the one or more logistic regression feature selection models or techniques using off-policy evaluation. The performance level may be indicated by one or more performance metrics, such as an average reward, one or more value functions, one or more policy quality measures, and/or one or more error rates, among other examples.

As shown by reference number 125, the feature selection device may determine, based on the off-policy evaluation, a ranking of the set of features (e.g., the set of features used to estimate the off-policy evaluation). The ranking may indicate an order of importance of the set of features on the performance level. For example, the feature selection device may order the set of features from a greater impact on the performance level to a lower impact on the performance level. In other words, the ranking may order the set of features from least importance to greatest importance to the performance level of the machine learning model. The feature selection device may determine the ranking using a classification model. The classification model may include a decision tree, a random forest model, and/or another type of classification model.

In some implementations, the feature selection device may determine, using the classification model, feature importance scores for respective features from the set of features. The feature importance scores may indicate an impact of the respective features on the performance level. The feature selection device may determine the ranking based on the feature importance scores.

For example, the feature selection device may build a decision tree model based on the off-policy evaluation of the machine learning model (e.g., where a target variable represents the outcome to be predicted or a recommended, and the predictor variables represent the set of features). The feature selection device may evaluate splitting criteria of the decision tree model. The splitting criteria may include an information gain, a Gini impurity, and/or another splitting criteria. For each split, the feature selection device may determine a value of the splitting criteria for a given feature. The feature selection device may accumulate the values of the splitting criteria for respective features. The accumulated values of the splitting criteria may be the feature importance scores for the set of features. The feature selection device may order the set of features based on the accumulated values of the splitting criteria (e.g., where a higher value indicates a more important feature as the higher value indicates a greater contribution to the decision making process within the decision tree).

As shown in FIG. 1B, and by reference number 130, the feature selection device may generate, based on the ranking, one or more subsets of features from the set of features (e.g., the set of features used in the off-policy evaluation of the machine learning model). For example, the feature selection device may generate the one or more subsets of features from the set of features based on iteratively removing one or more features, from the set of features, in accordance with the ranking.

For example, the feature selection device may remove, in accordance with the ranking, a first feature from the set of features to generate a first subset of features from the one or more subsets of features. The feature selection device may remove, in accordance with the ranking, a second feature from the first subset of features to generate a second subset of features from the one or more subsets of features. The ranking may indicate that the second feature has a greater impact on the performance level than the first feature. In other words, the feature selection device may iteratively remove one or more features from the set of features in an order from lesser impact to greater impact on the performance level (e.g., the performance level determined via off-policy evaluation, as described elsewhere herein).

For example, the set of features may include a feature 1, a feature 2, a feature 3, a feature 4, and a feature 5. The ranking may order the features in an order of feature 1, feature 2, feature 3, feature 4, feature 5 (e.g., where feature 1 has the greatest importance and feature 5 has the least importance). To generate the one or more subsets of features, the feature selection device may remove one or more features have the least importance. For example, a first subset of features may include {feature 1, feature 2, feature 3, feature 4}. To generate a next subset of features, the feature selection device may remove a next one or more features have the least importance. For example, a second subset of features may include {feature 1, feature 2, feature 3}. The feature selection device may generate one or more other subsets of features in a similar manner (e.g., by iteratively removing one or more least important features from remaining features).

Although examples are described above associated with removing features linearly in an order indicated by the ranking, in some other implementations the feature selection device may iteratively remove features from the set of features in a different order or a different manner. For example, a first subset of features may include a top N^{th} percentile of the set of features (e.g., the top 90% of features in order of importance), a second subset of features may include a top X^{th} percentile of the set of features (e.g., the top 80% of features in order of importance), and so on. As another example, the feature selection device may generate the one or more subset of features to generate different combinations of features. For example, the set of features may include features 1 through 20 (e.g., where feature 1 is the most important feature and feature 20 is the least important feature). The feature selection device may generate a first subset of features that includes features 1 through 19 (e.g., removing the least important feature, feature 20). The feature selection device may generate a second subset of features that includes features 1 through 18 and feature 20 (e.g., removing the second least important feature, feature 19, but adding the least important feature, feature 20). The feature selection device may generate a third subset of features that includes features 1 through 17 and features 19 and 20 (e.g., removing the third least important feature, feature 18, but adding the second least important feature, feature 19). The feature selection device may generate different subsets of features (e.g., based on and/or in accordance with the ranking) in any manner to obtain the one or more subsets of features.

As shown by reference number 135, the feature selection device may determine, for each subset of features, a performance level of the machine learning model (e.g., using off-policy evaluation). For example, the target policy of the off-policy evaluation may be the subset(s) of features. For example, the feature selection device may generate a first subset of features by removing the one or more least important features from the set of features (e.g., as indicated by the rankings and as described in connection with reference number 130). The feature selection device may perform off-policy evaluation of the machine learning model using the first subset of features (e.g., as the target policy) to obtain a first performance level of the machine learning model (e.g., where the first performance level is associated with the first subset of features). The feature selection device may generate a second subset of features by removing one or more least important features from the first subset of features (e.g., as indicated by the rankings and as described in connection with reference number 130). The feature selection device may perform off-policy evaluation of the machine learning model using the second subset of features (e.g., as the target policy) to obtain a second performance level of the machine learning model (e.g., where the second performance level is associated with the second subset of features). The feature selection device may perform off-policy evaluation to obtain performance levels for respective subsets of features.

This enables the feature selection device to evaluate the performance of the model as a whole for different subsets of features. For example, the one or more logistic regression feature selection models and/or techniques may enable the feature selection device to select a set of features that improve a performance of respective logistic regression models included in the machine learning model. The off-policy evaluation of the subsets of features may enable the feature selection device to evaluate the performance of the machine learning model for personalization and/or the ability to differentiate recommendations for different users and/or for different data.

As shown by reference number 140, the feature selection device may select, based on the off-policy evaluation of the subset(s) of features, a subset of features (e.g., from the one or more subset of features). For example, the feature selection device may determine, based on the off-policy evaluation, the subset of features that results in the best personalization performance (e.g., the best performance level) of the machine learning model. In other words, the off-policy evaluation may enable the feature selection device to ensure that a personalization benefit of using a feature (e.g., a variable) outweighs the computational cost of using the feature.

In some implementations, the feature selection device may select a subset of features that is associated with a highest performance level of the machine learning model (e.g., based on the off-policy evaluation of the one or more subsets of features). In some implementations, the subset of features may be the set of features (e.g., in an example where removing features from the set of features degrades the performance level of the machine learning model). In other implementations, the subset of features may include less features than the set of features. This may reduce the dimensionality of input to the machine learning model, thereby conserving computing resources, processing resources, and/or memory resources associated with using the machine learning model.

As shown in FIG. 1C, and by reference number 145, the feature selection device may configure the machine learning model (or cause the machine learning model to be configured) to use the subset of features (e.g., that were determined as described above in connection with reference number 140). In some implementations, the feature selection device (or another device) may train the machine learning model using the subset of features. For example, the machine learning model may be trained using a set of observations. The set of observations may be obtained from training data (e.g., historical data), such as data gathered during one or more processes described herein. The set of observations may include the subset of features. The subset of features may include one or more variables, and a variable may be referred to as a feature. The feature selection device (or another device) may train the machine learning model (or may cause the machine learning model to be trained) using training data for the subset of features.

As shown by reference number 150, the feature selection device (or another device) may obtain input data (e.g., from the client device). The input data may include data associated with the subset of features. As shown by reference number 155, the feature selection device may obtain one or more recommendations from the machine learning model based on the input data. For example, the feature selection device (or another device) may provide (e.g., input) data (based on the input data) for respective features from the subset of features. The machine leaning model may output one or more recommendations based on the provided data.

As shown by reference number 160, the feature selection device (or another device) may provide, and the client device may obtain, the one or more recommendations. Additionally, or alternatively, the feature selection device (or another device) may perform one or more actions based on the one or more recommendations. For example, the feature selection device (or another device) may perform one or more automated actions based on, or in response to, the one or more recommendations. For example, the one or more recommendations may indicate a recommended communication for a given user. An automated action may include causing the recommended communication to be transmitted to a device or account (e.g., an email account) associated with the given user.

As a result, a dimensionality of the input data for the machine learning model may be reduced. This may conserve consuming computing resources, processing resources, and/or memory resources, among other examples, that would have otherwise been used for input data associated with a higher dimensionality. Additionally, by using off-policy evaluation of the machine learning model during the feature selection process, different sets or subsets of features may be evaluated without re-training the reinforcement learning model (e.g., the reinforcement learning model may be evaluated on a different policy or data distribution than the one the reinforcement learning model was trained on using off-policy evaluation), thereby conserving computing resources, processing resources, and/or memory resources, among other examples, that would have otherwise been used to collect data for each of the different sets or subsets of features, re-train the machine learning model for each of the different sets or subsets of features, and/or execute the machine learning model (e.g., after re-training) for each of the different sets or subsets of features, among other examples. Further, by using the off-policy evaluation of the machine learning model during the feature selection process, a set (or subset) of features that improves the personalization effect or performance of the machine learning model may be selected and/or identified (e.g., by enabling a benefit for personalization compared to a processing cost of using a given feature to be quickly and easily evaluated via the off-policy evaluation).

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a feature selection device 210, a client device 220, and a network 230. Devices of environment 200 may interconnect via wired connections, wireless connections, or a combination of wired and wireless connections.

The feature selection device 210 may include one or more devices capable of receiving, generating, storing, processing, providing, and/or routing information associated with feature selection for reinforcement learning models, as described elsewhere herein. The feature selection device 210 may include a communication device and/or a computing device. For example, the feature selection device 210 may include a server, such as an application server, a client server, a web server, a database server, a host server, a proxy server, a virtual server (e.g., executing on computing hardware), or a server in a cloud computing system. In some implementations, the feature selection device 210 may include computing hardware used in a cloud computing environment.

The client device 220 may include one or more devices capable of receiving, generating, storing, processing, and/or providing information associated with feature selection for reinforcement learning models, as described elsewhere herein. The client device 220 may include a communication device and/or a computing device. For example, the client device 220 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 230 may include one or more wired and/or wireless networks. For example, the network 230 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 230 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with feature selection for reinforcement learning models. The device 300 may correspond to the feature selection device 210 and/or the client device 220. In some implementations, the feature selection device 210 and/or the client device 220 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

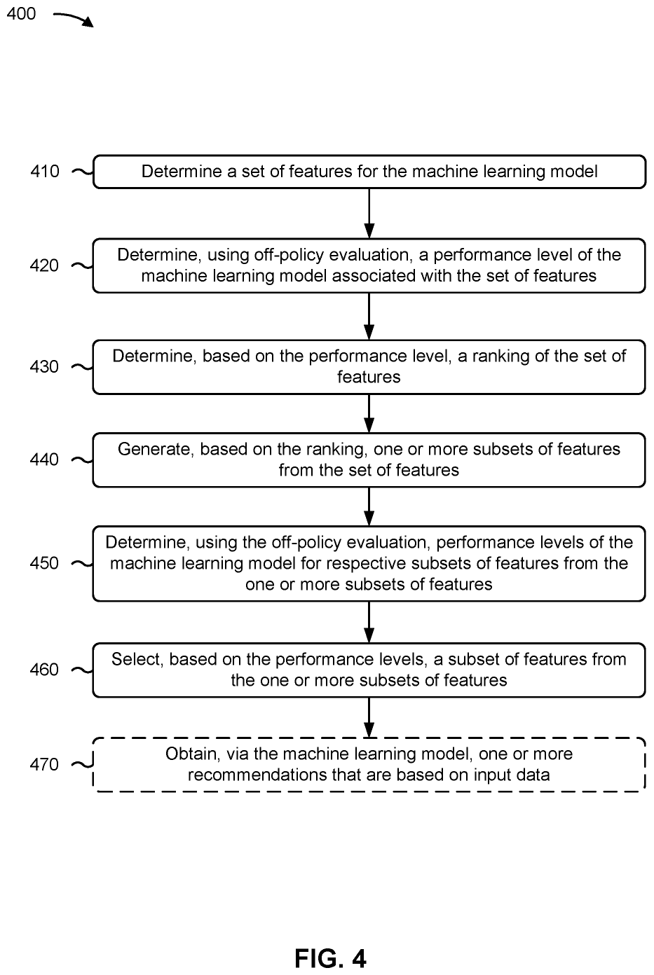

FIG. 4 is a flowchart of an example process 400 associated with feature selection for reinforcement learning models. In some implementations, one or more process blocks of FIG. 4 may be performed by the feature selection device 210. In some implementations, one or more process blocks of FIG. 4 may be performed by another device or a group of devices separate from or including the feature selection device 210, such as the client device 220. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include determining a set of features for the machine learning model (block 410). For example, the feature selection device 210 (e.g., using processor 320 and/or memory 330) may determine a set of features for the machine learning model, as described above in connection with reference number 105, reference number 110, and/or reference number 115 of FIG. 1A. As an example, the feature selection device 210 may determine the set of features using one or more logistic regression feature selection models or techniques. The one or more logistic regression feature selection models or techniques may enable the feature selection device 210 to determine or select one or more features (e.g., the set of features) that improve the performance of one or more logistic regression models included in the machine learning model.

As further shown in FIG. 4, process 400 may include determining, using off-policy evaluation, a performance level of the machine learning model associated with the set of features (block 420). For example, the feature selection device 210 (e.g., using processor 320 and/or memory 330) may determine, using off-policy evaluation, a performance level of the machine learning model associated with the set of features, as described above in connection with reference number 120 of FIG. 1A. As an example, the feature selection device 210 may perform off-policy evaluation to determine a performance level of the machine learning model using the set of features as a target policy associated with the off-policy evaluation.

As further shown in FIG. 4, process 400 may include determining, based on the performance level, a ranking of the set of features (block 430). For example, the feature selection device 210 (e.g., using processor 320 and/or memory 330) may determine, based on the performance level, a ranking of the set of features, as described above in connection with reference number 125 of FIG. 1A. As an example, the feature selection device 210 may order the set of features from a greatest impact on the performance level (from a most important feature) to a least impact on the performance level (e.g., to a least important feature). For example, the feature selection device 210 may determine the ranking using a classification model, such as a decision tree.

As further shown in FIG. 4, process 400 may include generating, based on the ranking, one or more subsets of features from the set of features (block 440). For example, the feature selection device 210 (e.g., using processor 320 and/or memory 330) may generate, based on the ranking, one or more subsets of features from the set of features, as described above in connection with reference number 130 of FIG. 1B. As an example, the feature selection device 210 may iteratively remove, in an order indicated by the ranking, one or more features from the set of features to generate the one or more subsets of features.

As further shown in FIG. 4, process 400 may include determining, using the off-policy evaluation, performance levels of the machine learning model for respective subsets of features from the one or more subsets of features (block 450). For example, the feature selection device 210 (e.g., using processor 320 and/or memory 330) may determine, using the off-policy evaluation, performance levels of the machine learning model for respective subsets of features from the one or more subsets of features, as described above in connection with reference number 135 of FIG. 1B. As an example, the feature selection device may evaluate the performance levels of the machine learning model for each subset of features using off-policy evaluation. For example, the feature selection device 210 may use the subset of features as target policies in the off-policy evaluation.

As further shown in FIG. 4, process 400 may include selecting, based on the performance levels, a subset of features from the one or more subsets of features (block 460). For example, the feature selection device 210 (e.g., using processor 320 and/or memory 330) may select, based on the performance levels, a subset of features from the one or more subsets of features, as described above in connection with reference number 140 of FIG. 1B. As an example, the feature selection device may select the subset of features that results in a best performance of the machine learning model based on the off-policy evaluation.

In some implementations, as further shown in FIG. 4, process 400 may optionally include obtaining, via the machine learning model, one or more recommendations that are based on input data (block 470). For example, the feature selection device 210 (e.g., using processor 320 and/or memory 330) may obtain, via the machine learning model, one or more recommendations that are based on input data, as described above in connection with reference number 155 of FIG. 1C. In some implementations, the machine learning model uses the subset of features (e.g., is trained using the subset of features).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for feature selection for a reinforcement learning model, the system comprising:
one or more memories; and
one or more processors, communicatively coupled to the one or more memories, configured to:
determine, via one or more logistic regression feature selection models, a set of features for the reinforcement learning model;
determine, using off-policy evaluation, a performance level of the reinforcement learning model when using the set of features;
determine, based on the performance level and using a classification model, a ranking of the set of features, wherein the ranking indicates an order of importance of the set of features on the performance level;
generate one or more subsets of features from the set of features based on iteratively removing one or more features, from the set of features, in accordance with the ranking;
determine, using the off-policy evaluation, one or more performance levels for respective subsets of features from the one or more subsets of features; and
select a subset of features, from the one or more subsets of features, to be used for the reinforcement learning model based on the one or more performance levels.

2. The system of claim 1, wherein the reinforcement learning model is associated with multiple logistic regression models, and wherein the one or more processors, to determine the set of features, are configured to:
determine the set of features using multiple logistic regression accuracy models associated with respective logistic regression models from the multiple logistic regression models.

3. The system of claim 1, wherein the classification model includes a decision tree.

4. The system of claim 1, wherein the one or more processors, to generate the one or more subsets of features, are configured to:
remove, in accordance with the ranking, a first feature from the set of features to generate a first subset of features from the one or more subsets of features; and
remove, in accordance with the ranking, a second feature from the first subset of features to generate a second subset of features from the one or more subsets of features.

5. The system of claim 4, wherein the ranking indicates that the second feature has a greater impact on the performance level than the first feature.

6. The system of claim 1, wherein one or more processors, to generate the one or more subsets of features, are configured to:
remove the one or more features from the set of features in the order,
wherein the order is from lesser impact to greater impact on the performance level.

7. The system of claim 1, wherein one or more processors, to determine the ranking, are configured to:
determine, using the classification model, feature importance scores for respective features from the set of features,
wherein the feature importance scores indicate an impact of the respective features on the performance level; and
determine the ranking based on the feature importance scores.

8. The system of claim 1, wherein the reinforcement learning model is a multinomial Bayesian logistic regression model.

9. A method of feature selection for a machine learning model, comprising:
determining, by a device, a set of features for the machine learning model;
determining, by the device and using off-policy evaluation, a performance level of the machine learning model associated with the set of features;
determining, by the device and based on the performance level, a ranking of the set of features;
generating, by the device and based on the ranking, one or more subsets of features from the set of features;
determining, by the device and using the off-policy evaluation, performance levels of the machine learning model for respective subsets of features from the one or more subsets of features;
selecting, by the device and based on the performance levels, a subset of features from the one or more subsets of features; and
obtaining, by the device and via the machine learning model, one or more recommendations that are based on input data, wherein the machine learning model uses the subset of features.

10. The method of claim 9, wherein determining the ranking of the set of features comprises:
determining, using a classification model, feature importance scores for respective features from the set of features,
wherein the feature importance scores indicate an importance of the respective features to the performance level; and
determining the ranking based on the feature importance scores,
wherein the ranking orders the set of features from least importance to greatest importance to the performance level.

11. The method of claim 10, wherein the classification model includes a random forest model.

12. The method of claim 9, wherein generating the one or more subsets of features comprises:
iteratively removing one or more features from the set of features in an order indicated by the ranking.

13. The method of claim 9, wherein the subset of features is associated with a highest performance level from the performance levels.

14. The method of claim 9, wherein the off-policy evaluation includes a random holdout direct matching evaluation.

15. The method of claim 9, wherein the machine learning model is a reinforcement learning model that includes one or more logistic regression models and a classification model that classifies an input based on outputs of the one or more logistic regression models.

16. A non-transitory computer-readable medium storing a set of instructions, the set of instructions comprising:
one or more instructions that, when executed by one or more processors of a device, cause the device to:
determine, via one or more logistic regression feature selection models, a set of features for a reinforcement learning model;
determine, using off-policy evaluation, a performance level of the reinforcement learning model when using the set of features;
determine, based on the performance level and using a classification model, a ranking of the set of features, wherein the ranking indicates an order of importance of the set of features on the performance level;
generate one or more subsets of features from the set of features based on iteratively removing one or more features, from the set of features, in accordance with the ranking;
determine, using the off-policy evaluation, one or more performance levels for respective subsets of features from the one or more subsets of features;
select, based on the one or more performance levels, a subset of features from the one or more subsets of features; and
provide the subset of features for use with the reinforcement learning model.

17. The non-transitory computer-readable medium of claim 16, wherein the reinforcement learning model is associated with multiple logistic regression models, and wherein the one or more processors, to determine the set of features, are configured to:
determine the set of features using multiple logistic regression accuracy models associated with respective logistic regression models from the multiple logistic regression models.

18. The non-transitory computer-readable medium of claim 16, wherein the classification model includes at least one of a decision tree or a random forest model.

19. The non-transitory computer-readable medium of claim 16, wherein the one or more instructions, that cause the device to generate the one or more subsets of features, cause the device to:
remove, in accordance with the ranking, a first feature from the set of features to generate a first subset of features from the one or more subsets of features; and
remove, in accordance with the ranking, a second feature from the first subset of features to generate a second subset of features from the one or more subsets of features.

20. The non-transitory computer-readable medium of claim 16, wherein one or more processors, to determine the ranking, are configured to:
determine, using the classification model, feature importance scores for respective features from the set of features,
wherein the feature importance scores indicate an impact of the respective features on the performance level; and
determine the ranking based on the feature importance scores.
